(19) United States
(12) Patent Application Publication
(10) Pub. No.: US 2014/0008170 A1
(43) Pub. Date: Jan. 9, 2014

(54) INTEGRATED DRIVE GENERATOR DISCONNECT ASSEMBLY

(71) Applicants: Henry R. Vanderzyden, Byron, IL (US); Jonathan C. Dell, Carpentersville, IL (US)

(72) Inventors: Henry R. Vanderzyden, Byron, IL (US); Jonathan C. Dell, Carpentersville, IL (US)

(21) Appl. No.: 13/542,784

(22) Filed: Jul. 6, 2012

(51) Int. Cl. F16D 43/25; F16D 43/20

(52) U.S. Cl. 192/56.5; 192/82 T

(57) ABSTRACT

A disconnect assembly for an integrated drive generator includes an input shaft configured to receive a rotational input. A coupling member is selectively coupled to the input shaft by dog teeth. A biasing element is configured to disconnect the dog teeth and decouple the coupling member from the input shaft. A thermal coupling opposes the biasing element to maintain engagement between the dog teeth in an unmelted state. The thermal coupling is constructed from a eutectic solder material of 91.3% tin and 8.7% zinc by weight.

### BACKGROUND

This disclosure relates to a disconnect assembly for an integrated drive generator, for example. The integrated drive generator may be used in aerospace applications, for example.

One example type of integrated drive generator (IDG) includes a generator, a hydraulic unit and a differential assembly arranged in a common housing. The differential assembly is operatively coupled to a gas turbine engine via an input shaft. The rotational speed of the input shaft varies during the operation of the gas turbine engine. The hydraulic unit cooperates with the differential assembly to provide a constant speed to the generator throughout engine operation.

The differential assembly receives an input from an input shaft, which may be operatively coupled to a gas turbine engine spool. The hydraulic unit converts the variable rotational speed of the input shaft to provide a fixed output rotational speed to the generator. It may be desirable to disconnect the rotational drive to the generator during certain undesired conditions. For example, during high temperatures, the rotational drive from the input shaft may be disconnected from the generator to protect the generator or other components from damage.

The input shaft, which is steel, typically includes a weakened area in the event that components within the IDG bind. The weakened area breaks under such circumstances, protecting the mechanical components upstream from the IDG. Previously, this weakened area had a nominal diameter of 0.477 inch (1.21 cm) at a nominal hardness of 40 HRC. The input shaft had a shear torque (in-lbs) to nominal diameter (in) ratio of 6960-7470, which may break earlier than desired in some applications.

One type of disconnect assembly has used a thermal coupling constructed from a eutectic solder made from an alloy of tin, lead and silver, which melts at 354° F. (179° C.). The thermal coupling melts at undesirably high temperatures to uncouple the input shaft from the differential assembly and cease rotational drive to the generator, preventing the generator from overheating. The disconnect assembly includes a biasing element that urges engageable dog teeth between the input shaft and another structure out of engagement with one another once the thermal coupling material has melted. This thermal coupling material is subject to creep and may compress more than desired during a period of operation that is less than the desired maintenance period, enabling the dog teeth to at least partially disengage from one another.

### SUMMARY

In one exemplary embodiment, a disconnect assembly for an integrated drive generator includes an input shaft configured to receive a rotational input. A coupling member is selectively coupled to the input shaft by dog teeth. A biasing element is configured to disconnect the dog teeth and decouple the coupling member from the input shaft. A thermal coupling opposes the biasing element to maintain engagement between the dog teeth in an unmelted state. The thermal coupling is constructed from a eutectic solder material of 91.3% tin and 8.7% zinc by weight.

In a further embodiment of any of the above, the disconnect assembly includes a generator operatively coupled to the input shaft by the coupling member with the dog teeth engaged with one another.

In a further embodiment of any of the above, the disconnect assembly includes a differential assembly operatively connected between the input shaft and the generator.

In a further embodiment of any of the above, the differential assembly includes a carrier. The coupling member is rotationally fixed relative to the carrier by a splined connection. The coupling member is axially slidable relative to the carrier.

In a further embodiment of any of the above, the thermal coupling has a melting temperature of 390° F. (199° C.).

In another exemplary embodiment, a method of disconnecting rotational drive elements from one another, includes the steps of melting a thermal coupling at a melting point of 390° F. (199° C.), and urging dog teeth out of engagement with one another.

In a further embodiment of any of the above, the thermal coupling is a eutectic solder material of 91.3% tin and 8.7% zinc by weight.

In another exemplary embodiment, a disconnect assembly for an integrated drive generator includes an input shaft configured to receive a rotational input. The input shaft has first and second ends. Splines are arranged at the first end and have a spline diameter provided by a spline contact line. Dog teeth are arranged at the second end and has a dog tooth contact line. A weakened area has a weakened diameter. The input shaft has a shear torque (in-lbs) to nominal weakened diameter (in) ratio of 9390 to 10,090.

In a further embodiment of any of the above, the ratio of the spline diameter relative to the weakened diameter is 1.39 to 1.48.

In a further embodiment of any of the above, the input shaft has a length extending from the dog tooth contact line to the first end at the spline contact line, and a ratio of the length to the weakened diameter of 5.38 to 5.70.

In a further embodiment of any of the above, the length is in the range of 3.083 inch (7.83 cm) to 3.109 inch (7.90 cm).

In a further embodiment of any of the above, the weakened area is an arcuate groove circumscribing an outer diameter of the input shaft.

In another exemplary embodiment, an integrated drive generator includes a generator. The integrated drive generator includes a differential assembly and a hydraulic unit arranged within a common housing. An input shaft is configured to receive a rotational input. The hydraulic unit is configured to cooperate with the differential assembly to convert the variable rotational speed from the input shaft to provide a fixed rotational output speed to the generator. The input shaft has first and second ends. Splines are arranged at the first end and has a spline diameter provided by a spline contact line. Dog teeth are arranged at the second end and have a dog tooth contact line. The input shaft includes a weakened area having a weakened diameter. The input shaft has a shear torque (in-lbs) to nominal weakened diameter (in) ratio of 9390 to 10,090. A coupling member is selectively coupled to the input shaft by dog teeth. A biasing element is configured to disconnect the dog teeth and decouple the coupling member from the input shaft. A thermal coupling opposes the biasing element to maintain engagement between the dog teeth in an unmelted state. The thermal coupling is constructed from a eutectic solder material of 91.3% tin and 8.7% zinc by weight.

In a further embodiment of any of the above, the integrated drive generator includes a generator operatively coupled to the input shaft by the coupling member with the dog teeth engaged with one another.

In a further embodiment of any of the above, the integrated drive generator includes a differential assembly operatively connected between the input shaft and the generator.

In a further embodiment of any of the above, the differential assembly includes a carrier. The coupling member is rotationally fixed relative to the carrier by a splined connection. The coupling member is axially slidable relative to the carrier.

In a further embodiment of any of the above, the thermal coupling has a melting temperature of 390° F. (199° C.).

In a further embodiment of any of the above, the ratio of the spline diameter relative to the weakened diameter is 1.39 to 1.48.

In a further embodiment of any of the above, the input shaft has a length extending from the dog tooth contact line to the first end at the spline contact line, and a ratio of the length to the weakened diameter of 5.38 to 5.70.

In a further embodiment of any of the above, the length is in the range of 3.083 inch (7.83 cm) to 3.109 inch (7.90 cm).

In a further embodiment of any of the above, the weakened area is an arcuate groove circumscribing an outer diameter of the input shaft.

### BRIEF DESCRIPTION OF THE DRAWINGS

The disclosure can be further understood by reference to the following detailed description when considered in connection with the accompanying drawings wherein:

FIG. 1 is a highly schematic view of a generator system.

FIG. 2 is a cross-sectional schematic view of an example integrated drive generator.

FIG. 3 is a schematic perspective view of a generator, a hydraulic unit and a differential assembly of the integrated drive generator shown in FIG. 2.

FIG. 4 is a partial cross-sectional view of a differential assembly having a disconnect assembly with an input shaft.

FIG. 5 is partial cross-sectional view of the input shaft decoupled from the differential assembly.

### DETAILED DESCRIPTION

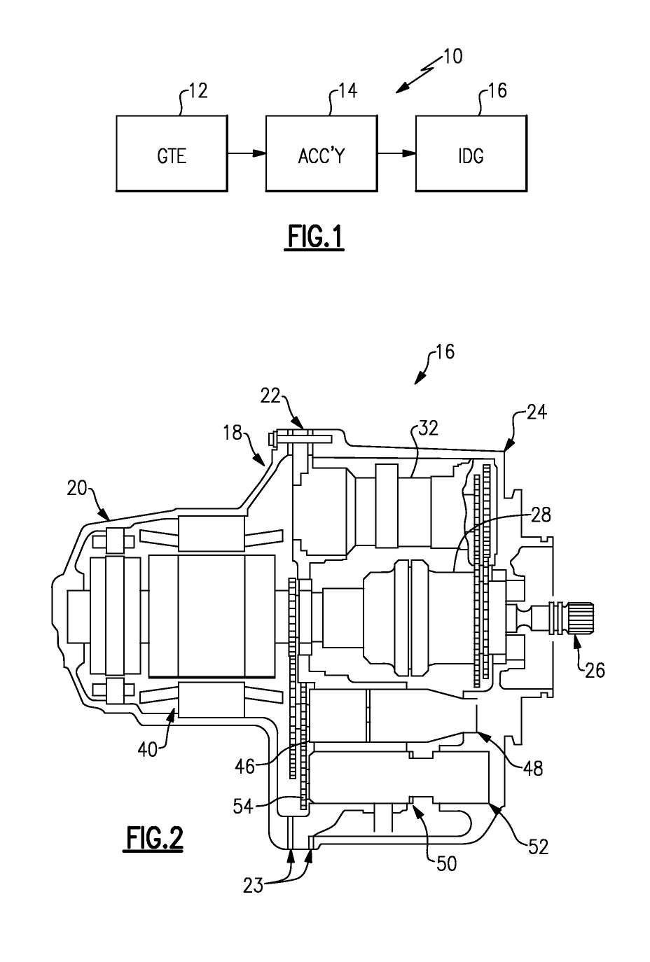

An example generator system 10 is schematically illustrated in FIG. 1. The system 10 includes a gas turbine engine 12 that provides rotational drive to an integrated drive generator (IDG) 16 through an accessory drive gearbox 14 mounted on the gas turbine engine 12. The accessory drive gearbox 14 is coupled to a spool of the engine 12, and the speed of the spool varies throughout engine operation.

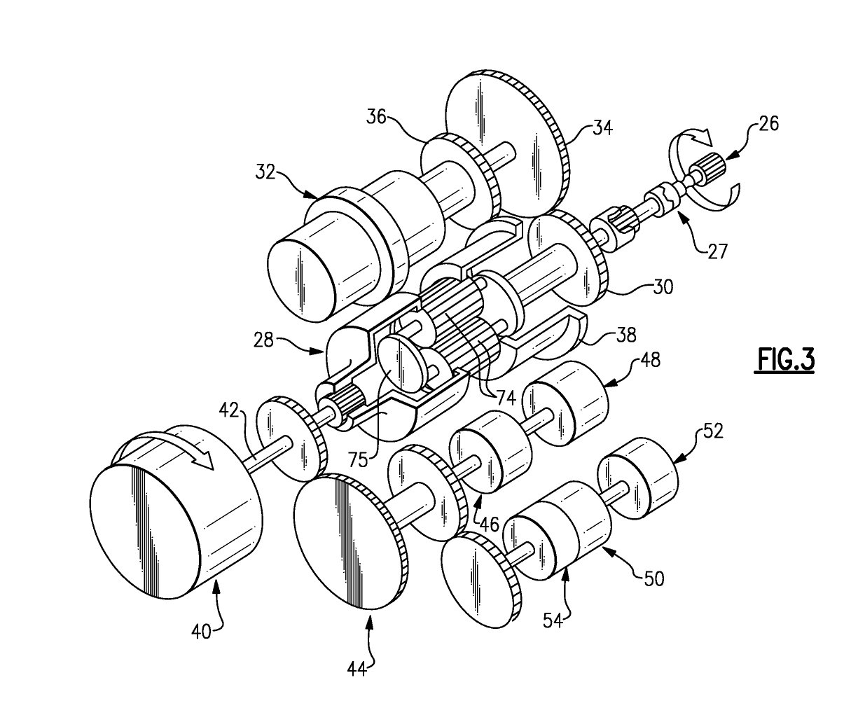

Referring to FIGS. 2 and 3, an example IDG 16 is illustrated. In the example, the IDG 16 includes a housing 18 having generator, center and input housing portions 20, 22, 24 secured to one another. A generator 40 is arranged in the generator housing portion 20. Seal plates 23 are provided on either side of the center housing 22 to seal the center housing 22 relative to the generator and input housing portions 20, 24.

An input shaft 26 receives rotational drive from the accessory drive gearbox 14. The rotational speed of the input shaft 26 varies depending upon the operation of the engine 12. To this end, as a result, a hydraulic unit 32 cooperates with the differential assembly 75 to convert the variable rotational speed from the input shaft 26 to provide a fixed rotational output speed to the generator 40.

The input shaft 26 rotationally drives a differential input gear 30 that is coupled to a hydraulic input gear 34 of the hydraulic unit 32. The differential input gear 30 is operatively coupled to the input shaft 26 by the disconnect assembly 27. The hydraulic output gear 36 is coupled to a speed trim output gear 38. The hydraulic unit 32 increases or decreases the rotational speed provided to the differential unit 75 from the hydraulic output gear 36 to provide a fixed rotational output speed, such as a 12,000 rpm speed. The variable rotational speed of the differential input gear 30 combines with the speed of the differential trim gear 38 to provide a fixed rotational speed to a differential output gear 28 and generator input shaft 42.

In the example, a gear train 44 cooperates with the generator input shaft 42, which rotates at a constant speed to rotationally drive a charge pump 46, deaerator 48, main scavenge pump 50, inversion pump 52 and generator scavenge pump 54. Thus, these components may be designed efficiently to operate at a fixed speed.

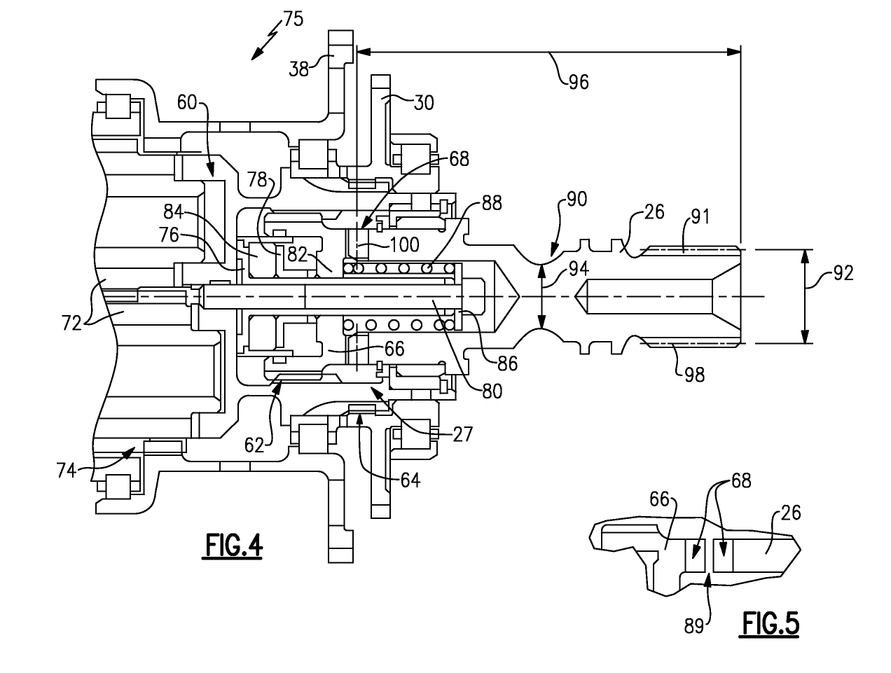

Referring to FIG. 4, the differential assembly 75 includes a carrier 60 that cooperates with the input shaft 26 to transfer rotational drive from the input shaft 26 to the differential input gear 30. In the example, the carrier 60 includes an internal spline connection 62 that cooperates with a coupling member 66. An external spline connection 64 cooperates with the differential input gear 30 to rotationally fix the differential input gear 30 relative to the carrier 60.

The internal spline connection 62 rotationally fixes the coupling member 66 to the carrier 60 while permitting the coupling member 66 to slide axially with respect to the carrier 60. A coupling of dog teeth 68 between the input shaft 26 and the coupling member 66 rotationally couples the input shaft 26 to the carrier 60 with the dog teeth 68 engaged with one another. The disconnect assembly 27 urges the coupling member 66 axially away from the input shaft 26 during high heat conditions enabling the dog teeth 68 to disengage from one another and provide a gap 89, as illustrated in FIG. 5. With the coupling member 66 in the position illustrated in FIG. 5, the input shaft 26 spins freely relative to the carrier 60, transferring no rotational input to the differential input gear 30. In this manner, rotational drive to the generator 40 (FIG. 1) ceases to prevent the generator 40 (FIG. 1) from overheating and protects the IDG 16 (FIG. 1).

The carrier 60 supports an array of gears 72, shown in FIGS. 3 and 4. It should be appreciated that the positioning of the components as illustrated in FIG. 3 is highly schematic in nature and may not necessarily correspond to the physical location of these components relative to one another, as appreciated by reference to FIG. 4. The gear 72 includes teeth 74 that cooperate with one another and intermesh with the differential speed trim gear 38 to receive rotational input from the hydraulic unit 32.

The disconnect assembly 27 includes first and second members 76, 78 that are concentric with one another. The second member 78 is slideably supported with respect to an outer diameter of the first member 76. A fastener 80 secures the first member 76 to the carrier 60. A thermal coupling 84 is arranged between the first and second members 76, 78. The dog teeth include a small engagement angle that permits a compressive force to be applied to the thermal coupling 84. The second member 78 engages a flange 82 of the coupling member 66. The spacing of the first and second members 76, 78 and the thermal coupling 84 are such that full engagement of the dog teeth 68 is maintained during normal operating temperatures. A biasing element 88, such as a helical spring, is provided between the flange 82 and a seat 86 to apply a biasing force to the coupling member 66 in a direction away from the input shaft 26.

At undesirably high temperatures, the thermal coupling material melts, which permits the biasing element 88 to urge the coupling member 66 away from the input shaft 26 such that the dog teeth 68 are separated from one another to provide the gap 89, as shown in FIG. 5. In one example, the thermal coupling 84 is provided by a eutectic solder material of 91.3% tin and 8.7% zinc by weight, for example. This composition melts at 390° F. (199° C.). The thermal coupling 84 exhibits good creep characteristics, for example, about 4.4 times high compressive stress capability and 49 times longer life for the same operating parameters than the previous thermal coupling material that melted at 354° F. (179° C.).

The input shaft 26 includes splines 91 at one end, which engage with corresponding structure of the accessory drive gearbox 14. The dog teeth 68 are arranged at the opposite end of the shaft relative to the splines 91. An intermediate region of the input shaft 26 includes a weakened area 90 provided by an arcuate groove circumscribing an outer diameter of the input shaft 26. The weakened area 90 is designed to break at a particular torque to prevent damage to the accessory drive box 14 and engine 12. The weakened area 90 includes a diameter 94, which may be 0.559 inch (1.42 cm) nominally at a nominal 40 HRC. The input shaft 26 has a shear torque (in-lbs) to nominal diameter (in) ratio of 9390-10,090. The splines 91 include a spline pitch diameter 92 defined relative to a spline tooth contact line 98. The ratio of the spline diameter 92 relative to the weakened diameter 94 is 1.39 to 1.48.

The dog teeth 68 of the input shaft 26 include a dog tooth contact line 100. The input shaft 26 has a length 96 extending from the dog tooth contact line 100 to an end of the input shaft 26 at the spline contact line 98. The length 96 is in the range of 3.083 inch (7.83 cm) to 3.109 inch (7.90 cm). The ratio of the length 96 to the weakened diameter 94 is 5.38 inch (13.7 cm) to 5.70 inch (14.5 cm). In this manner, the input shaft is able to withstand greater torque without fracturing.

Although an example embodiment has been disclosed, a worker of ordinary skill in this art would recognize that certain modifications would come within the scope of the claims. For that reason, the following claims should be studied to determine their true scope and content.

What is claimed is:

1. A disconnect assembly for an integrated drive generator comprising:
an input shaft configured to receive a rotational input;
a coupling member selectively coupled to the input shaft by dog teeth;
a biasing element configured to disconnect the dog teeth and decouple the coupling member from the input shaft; and
a thermal coupling opposing the biasing element to maintain engagement between the dog teeth in an unmelted state, the thermal coupling constructed from a eutectic solder material of 91.3% tin and 8.7% zinc by weight.

2. The disconnect assembly according to claim 1, comprising a generator operatively coupled to the input shaft by the coupling member with the dog teeth engaged with one another.

3. The disconnect assembly according to claim 2, comprising a differential assembly operatively connected between the input shaft and the generator.

4. The disconnect assembly according to claim 3, wherein the differential assembly includes a carrier, the coupling member rotationally fixed relative to the carrier by a splined connection, the coupling member axially slidable relative to the carrier.

5. The disconnect assembly according to claim 1, wherein the thermal coupling has a melting temperature of 390° F. (199° C.).

6. A method of disconnecting rotational drive elements from one another, comprising the steps of:
melting a thermal coupling at a melting point of 390° F. (199° C.); and
urging dog teeth out of engagement with one another.

7. The method according to claim 6, wherein the thermal coupling is a eutectic solder material of 91.3% tin and 8.7% zinc by weight.

8. A disconnect assembly for an integrated drive generator comprising:
an input shaft configured to receive a rotational input, the input shaft having first and second ends, splines arranged at the first end and having a spline diameter provided by a spline contact line, and dog teeth at the second end and having a dog tooth contact line; and
a weakened area having a weakened diameter, the input shaft has a shear torque (in-lbs) to nominal weakened diameter (in) ratio of 9390 to 10,090.

9. The disconnect assembly according to claim 8, wherein the ratio of the spline diameter relative to the weakened diameter is 1.39 to 1.48.

10. The disconnect assembly according to claim 8, wherein the input shaft has a length extending from the dog tooth contact line to the first end at the spline contact line, and a ratio of the length to the weakened diameter of 5.38 to 5.70.

11. The disconnect assembly according to claim 10, wherein the length is in the range of 3.083 inch (7.83 cm) to 3.109 inch (7.90 cm).

12. The disconnect assembly according to claim 8, wherein the weakened area is an arcuate groove circumscribing an outer diameter of the input shaft.

13. An integrated drive generator comprising:
a generator, a differential assembly and a hydraulic unit arranged within a common housing;
an input shaft configured to receive a rotational input, and the hydraulic unit configured to cooperate with the differential assembly to convert the variable rotational speed from the input shaft to provide a fixed rotational output speed to the generator, the input shaft having first and second ends, splines arranged at the first end and having a spline diameter provided by a spline contact line, and dog teeth at the second end and having a dog tooth contact line, the input shaft including a weakened area having a weakened diameter, the input shaft has a shear torque (in-lbs) to nominal weakened diameter (in) ratio of 9390 to 10,090;
a coupling member selectively coupled to the input shaft by dog teeth;
a biasing element configured to disconnect the dog teeth and decouple the coupling member from the input shaft; and
a thermal coupling opposing the biasing element to maintain engagement between the dog teeth in an unmelted state, the thermal coupling constructed from a eutectic solder material of 91.3% tin and 8.7% zinc by weight.

14. The integrated drive generator according to claim 13, comprising a generator operatively coupled to the input shaft by the coupling member with the dog teeth engaged with one another.

15. The integrated drive generator according to claim 14, comprising a differential assembly operatively connected between the input shaft and the generator.

16. The integrated drive generator according to claim 15, wherein the differential assembly includes a carrier, the coupling member rotationally fixed relative to the carrier by a splined connection, the coupling member axially slidable relative to the carrier.

17. The integrated drive generator according to claim 13, wherein the thermal coupling has a melting temperature of 390° F. (199° C.).

18. The integrated drive generator according to claim 13, wherein the ratio of the spline diameter relative to the weakened diameter is 1.39 to 1.48.

19. The integrated drive generator according to claim 13, wherein the input shaft has a length extending from the dog tooth contact line to the first end at the spline contact line, and a ratio of the length to the weakened diameter of 5.38 to 5.70.

20. The integrated drive generator according to claim 19, wherein the length is in the range of 3.083 inch (7.83 cm) to 3.109 inch (7.90 cm).

21. The integrated drive generator according to claim 13, wherein the weakened area is an arcuate groove circumscribing an outer diameter of the input shaft.
